(19) United States
(12) Patent Application Publication
(10) Pub. No.: US 2023/0244767 A1
(43) Pub. Date: Aug. 3, 2023

(54) EXTRAPOLATING RETURN DATA FOR A PLURALITY OF COMPUTING DEVICES

(71) Applicant: HEWLETT-PACKARD DEVELOPMENT COMPANY, L.P., Spring, TX (US)

(72) Inventors: Anton WIRANATA, Boise, ID (US); Nathaniel WHITLOCK, Vancouver, WA (US)

(73) Assignee: HEWLETT-PACKARD DEVELOPMENT COMPANY, L.P., Spring, TX (US)

(21) Appl. No.: 17/591,207

(22) Filed: Feb. 2, 2022

(51) Int. Cl. G06F 21/31; G06F 9/4401

(52) U.S. Cl. CPC G06F 21/316; G06F 9/4405; G06F 9/4411

(57) ABSTRACT

A method, comprising receiving telemetry data from a plurality of computing devices, the telemetry data including data obtained during setup of the plurality of computing devices. The method also includes receiving usage data pertaining to the plurality of computing devices, the usage data including data obtained during setup of the plurality of computing devices. The method includes receiving return data pertaining to a subpart of the plurality of computing devices, correlating the received telemetry data and the received usage data with the received return data. The method further includes extrapolating return data for a remainder of the plurality of computing devices based on the correlation between the received telemetry data, the received usage data, and the received return data.

### BACKGROUND

Enterprise data sources use different types of communication systems to connect with end users, such as consumers. For example, some enterprise data sources rely on electronic mail (email), telephone, etc., to communicate with consumers, who in turn can respond to the enterprise data sources. The quality of the user experience afforded to the user during an interaction between the user and the user support representative involves identifying if an interaction is associated with a positive sentiment or a negative sentiment.

### BRIEF DESCRIPTION OF THE DRAWINGS

FIG. 1 illustrates an example method for extrapolating return data for a plurality of computing devices, in accordance with the present disclosure.

FIG. 2 illustrates an example apparatus for extrapolating return data for a plurality of computing devices, in accordance with the present disclosure.

FIG. 3 illustrates an example apparatus for extrapolating return data for a plurality of computing devices, in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Understanding customer behavior is an important goal for any business, whether eCommerce or brick-and-mortar. Among other things, suppliers of a product may desire to know what a customer likes and dislikes, why customers prefer certain products over others, and why customers sometimes return their purchases. In the US, an estimated 8-10% of in-store sales are returned whereas online sales may result in 25-40% returns. US shoppers returned $396 billion worth of purchases in 2018. In the UK, logistic costs for returns are estimated at between £20bn and £60bn per year. Some research estimates that 68% of consumer electronics returns are labelled as NTF (No Trouble Found), and another 27% are due to buyer’s remorse which can occur for a variety of reasons.

Merchandise such as computing devices may be returned for a number of reasons including manufacturing defects, damage during shipping, ease of use, and ease of set-up. In some instances, merchandise simply does not perform as expected. Companies have the potential to maximize profit and improve customer satisfaction if the return of merchandise is prevented. However, predicting whether merchandise (including computing devices) will be returned is a difficult task. Defects in computing devices may be identified after the device is already in use by the customer. Similarly, the ease of use and ease of setup may be identified by the customer after the device has been used for some period of time. Moreover, whether the computing device meets expectations of the customer may be identified by the customer after the device has been used for some period of time. By knowing if a computing device is going to be returned or not, the manufacturer of the computing device can intervene to improve the customer experience and therefore reduce the number of returned products.

A method of extrapolating return data for a plurality of computing devices, in accordance with the present disclosure, includes receiving telemetry data from a plurality of computing devices, the telemetry data including data obtained during setup of the plurality of computing devices. The method also includes receiving usage data pertaining to the plurality of computing devices, the usage data including data obtained during setup of the plurality of computing devices, receiving return data pertaining to a subpart of the plurality of computing devices, correlating the received telemetry data and the received usage data with the received return data. The method further includes extrapolating return data for a remainder of the plurality of computing devices based on the correlation between the received telemetry data, the received usage data, and the received return data.

An apparatus for extrapolating return data for a plurality of computing devices, in accordance with the present disclosure includes a non-transitory computer-readable storage medium comprising instructions. The instructions, when executed, cause a computing device to receive telemetry data from a plurality of computing devices, the telemetry data including data obtained during a setup process of the plurality of computing devices. The instructions also cause the computing device to receive usage data pertaining to the plurality of computing devices, the usage data including data obtained during the setup process of the plurality of computing devices. The instructions also cause the computing device to receive return data pertaining to a subpart of the plurality of computing devices, and to create a predictive model to infer if a computing device among the plurality of computing devices is a return device, or non-returned device, by correlating the received telemetry data, the received usage data, and the received return data.

An apparatus for extrapolating return data for a plurality of computing devices, in accordance with the present disclosure includes a non-transitory computer-readable storage medium comprising instructions. The instructions, when executed, cause a computing device to receive return data from a subpart of a plurality of computing devices setup on a network hosted by the computing device. The instructions also cause the computing device to receive from the plurality of computing devices setup on the network, telemetry data associated with setup. The instructions also cause the computing device to receive usage data pertaining to the plurality of computing devices, the usage data including data obtained during setup of the plurality of computing devices. The instructions cause the computing device to correlate the telemetry data, the usage data, and the return data, and generate a return score for the plurality of computing devices based on the correlation of the telemetry data, the usage data, and the return data.

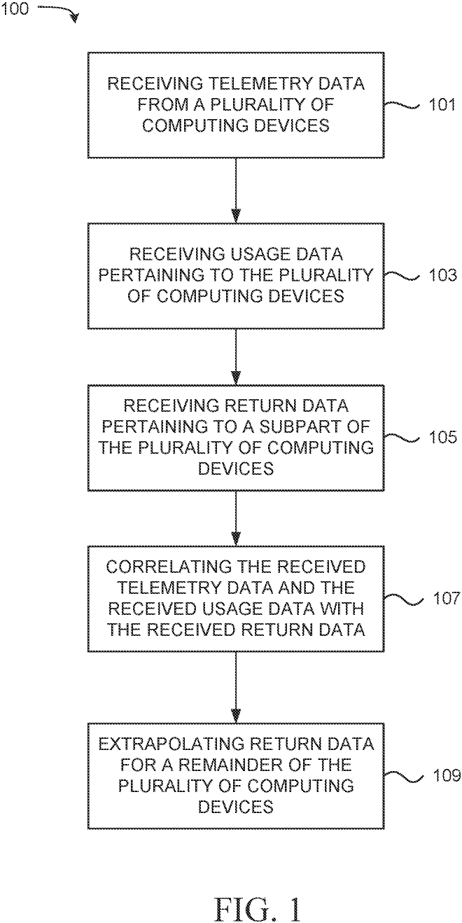

Turning now to the figures, FIG. 1 illustrates an example method 100 for extrapolating return data for a plurality of computing devices, in accordance with the present disclosure. As illustrated, the method 100 includes receiving telemetry data from a plurality of computing devices, the telemetry data including data obtained during setup of the plurality of computing devices at 101. Some example methods may provide cloud print platforms that provide services to enable the computing device to register to a cloud, help the cloud to connect to the cloud services, and ensure connectivity of the cloud services with the computing devices. The cloud services may establish trust with help of security solutions. A trust may be established between a computing device and a cloud platform. Accordingly, a plurality of computing devices may setup and register with a cloud service as part of setup of the computing device. During the setup process, telemetry data may be collected which pertains to the setup of the computing devices. As used herein, telemetry data refers to or includes data collected by each respective computing device during the setup process and automatically transmitted to the cloud service. Non-limiting examples of telemetry data collected include the time it took users to traverse the setup process, the number of attempts through the setup process, how many times items were shown to the user, and information regarding the types and/or frequency of errors encountered during the setup process. Examples are not so limited, and additional and/or different features of telemetry data may be obtained during the setup process.

At 103, the method 100 includes receiving usage data pertaining to the plurality of computing devices, the usage data including data obtained during setup of the plurality of computing devices. Usage data may relate to any aspect of the use of the computing device after and/or including setup. Non-limiting examples of usage data for a device may include a total number of pages printed, a number of pages printed in color, a number of pages printed in monochrome, a number of copies made, a number of scanned images, a number of times that a user connects to the device, a number of times that a user connects to the device via an application, the amount of time spent connected to the device, and an average session time, among others. The usage data may be in the form of free text, numerical ratings, and/or categorical selections.

In some examples, collecting usage data may include collecting usage data for a number of days after setup. As used herein, the term “delta days” refers to or includes a number of days from setup of the computing device for which usage data is collected. Each computing device may have a start date which corresponds with device setup and connecting to enterprise services. The delta days may be calculated by identifying from distributed return data, the average number of days that lapse from the start date to return of the computing device. Once the delta days are determined, the method at 103 includes collecting usage data pertaining to the plurality of computing devices for the delta days (e.g., for the number of days corresponding to the “delta days”). As such, the method may include determining an average number of days that lapse after setup to collect usage data.

At 105, the method 100 includes receiving return data pertaining to a subpart of the plurality of computing devices. As devices are returned, the serial number for the returned device may be obtained. The date that the device was returned as well as the reason for the return may also be retrieved. This serial number may be used to correlate the received return data with telemetry data for a particular computing device and identify factors that may have contributed to the return of the device. From the return data for a plurality of computing devices, an average return date may be determined. This average return date may then be used to determine the delta days for a remainder of the computing devices.

At 107, the method 100 includes correlating the received telemetry data and the received usage data with the received return data. In some examples, correlating the received telemetry data, the received usage data, and the received return data includes selecting a plurality of features from the telemetry data to correlate with the return data. For instance, perhaps the time it took users to traverse the setup process, and/or the number of attempts through the setup process may be selected for comparison to return data. In some examples, correlating the received telemetry data, the received usage data, and the received return data includes selecting a plurality of features from the received usage data to correlate with the return data. For instance, perhaps the number of times that a user connected to the device, the number of times that a user connected to the device via an application, and/or the amount of time spent connected to the device may be selected for comparison to return data.

In some examples, the method includes receiving call data pertaining to the plurality of computing devices. As used herein, call data refers to or includes data obtained during setup of the plurality of computing devices and pertaining to a user contacting a call center. For instance, during the setup process and/or during usage, the customer (e.g., user of the computing device) may contact a call center hosted by the manufacturer of the computing device. Non-limiting examples of the call data collected may include a number of days after setup upon which the user contacted the call center, how many times the user contacted the call center, what issue(s) the user was calling the call center about, and whether the user communicated to the call center that their issue was resolved. As such, the method 100 may also include correlating the received call data with the received return data, and extrapolating return data for the remainder of the plurality of computing devices based at least in part on the correlation between the received call data and the received return data.

A serial number for the computing device may be used to correlate received return data with telemetry data, usage data, and call data (as appropriate) for a particular computing device. While the telemetry data may be in numerical format, the return data, usage data, and/or call data may be in many different formats. As such, correlating the telemetry data with the return data, the usage data, and/or the call data may include converting the return, usage, and/or call data into numerical values. Examples are not so limited, and correlating the telemetry data with the return, usage, and/or call data may include converting the received telemetry data and the received return, usage, and/or call data into a common format. By correlating the return, usage, and/or call data with the telemetry data, predictive models may be generated which allow for return data to be predicted for a remainder of the computing devices that were not returned. For instance, if 10% of all computing devices were returned, return data may be extrapolated for the remaining 90% of computing devices. In such a manner, each computing device on the network may be identified as a device that is likely to be returned, or a device that is not likely to be returned.

At 109, the method 100 includes extrapolating return data for a remainder of the plurality of computing devices based on the correlation between the received telemetry data, the received usage data, and the received return data. In some examples, extrapolating return data includes determining for each of a remainder of the plurality of computing devices, whether the respective computing device would be classified as a return device or a non-returned device.

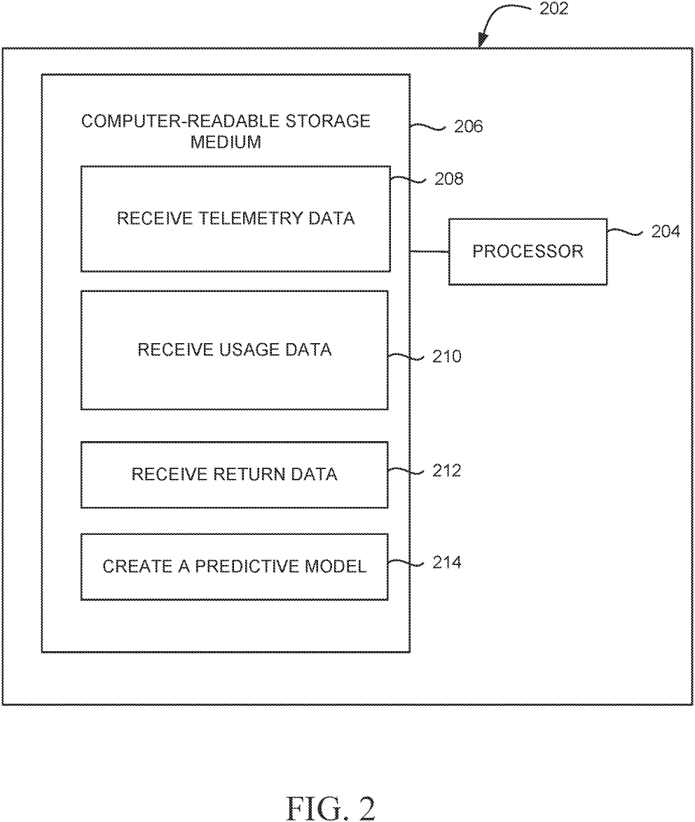

FIG. 2 illustrates an example computing device 202 for extrapolating return data for a plurality of computing devices, in accordance with the present disclosure. As illustrated in FIG. 2, the computing device 202 may include a processor 204, and a computer-readable storage medium 206. The computing device 202 may perform the method 100 illustrated in FIG. 1.

The processor 204 may be a central processing unit (CPU), a semiconductor-based microprocessor, and/or other hardware device suitable to control operations of the computing device 202. Computer-readable storage medium 206 may be an electronic, magnetic, optical, or other physical storage device that contains or stores executable instructions. Thus, computer-readable storage medium 206 may be, for example, Random Access Memory (RAM), an Electrically Erasable Programmable Read-Only Memory (EEPROM), a storage device, an optical disc, etc. In some examples, the computer-readable storage medium 206 may be a non-transitory storage medium, where the term ‘non-transitory’ does not encompass transitory propagating signals. As described in detail below, the computer-readable storage medium 206 may be encoded with a series of executable instructions 208-214.

In some examples, computer-readable storage medium 206 includes instructions 208 that when executed, cause the computing device 202 to receive telemetry data from a plurality of computing devices, the telemetry data including data obtained during a setup process of the plurality of computing devices. During the setup process, telemetry data may be sent from the computing device to the network. This telemetry data can be used to describe the experience the user had during the setup process. As described with regards to FIG. 1, telemetry data refers to or includes data collected by each respective computing device during the setup process and automatically transmitted to the cloud service. The telemetry data may be collected locally by computing device 202 and/or externally by a remote computing device.

The computer-readable storage medium 206 may also include instructions 210 that when executed, cause the computing device 202 to receive usage data pertaining to the plurality of computing devices. In various examples, the usage data includes data that is obtained during the setup process of the plurality of computing devices.

The computer-readable storage medium 206 may also include instructions 212 that when executed, cause the computing device 202 to receive return data pertaining to a subpart of the plurality of computing devices. The computer-readable storage medium 206 may also include instructions 214 that when executed, cause the computing device 202 to create a predictive model to infer if a computing devices among the plurality of computing devices is a return device, or a non-returned device, by correlating the received telemetry data, the received usage data, and/or the received return data. As used herein, a predictive model refers to or includes an algorithm that may predict future behavior based on historical data. Non-limiting examples of predictive models that may be used include logistic regression, random forest, catboost, or combinations thereof. This capability may enable the ability to understand the main drivers of why users return a device and highlight the parts of the setup process, device manufacturing, and/or operation which may be revised to produce improved user experiences. Using logistic regression, features may be identified in terms of the contribution to a user returning a device. For instance, the number of times a user is disconnected during usage may be determined to be a strong predictor of a user returning the device.

In some examples, computer-readable storage medium 206 may include instructions that when executed, cause the computing device 202 to determine which of a plurality of features of the telemetry data have a greatest association with return data as compared to a remainder of the plurality of features of the telemetry data. That is, using the collected data from the plurality of computing devices, the computing device 202 may identify which feature of the telemetry data most strongly predicted whether the user will return a device. As used herein, a feature of the telemetry data refers to or includes a metric that was collected during the setup process. For instance, time between one step of the setup process and a second step of the setup process may be a feature of the telemetry data, whereas a number of times setup instructions were referenced may be another feature of the telemetry data. For instance, the time between making a decision on a program offer and creating an account may be an important feature to drive predictive performance. As another example, the time between being provided an offer and completing enrollment in the offer may also be a strong predictor. Although examples are provided for determining which features of telemetry data are most strongly associated with return of a device, examples are not so limited. For instance, features of usage data, and/or call data may also be identified and determined to be a strong determining factor for whether a device will be returned.

In some examples, computer-readable storage medium 206 may include instructions that when executed, cause the computing device 202 to compute a relative score demonstrating the importance of one feature of the telemetry data relative to other features in terms of ability to impact the overall user experience. As such, the computer-readable storage medium 206 may include instructions that when executed, cause the computing device 202 to determine which features of usage data contribute the most to the computing device being returned.

In some examples, computer-readable storage medium 206 may include instructions that when executed, cause the computing device 202 to identify an aspect of the setup process to modify based on the predictive model. For instance, based on which feature is determined to have a greatest impact on the likelihood of a device being returned, the manufacturer may take active steps to address any issues and thereby prevent the return of devices. As an example, if a step of the setup process is identified as a strong predictor of device return, the manufacturer can modify the setup process and/or contact customers to assist with the setup process. As another example, if disconnects during usage are identified as a strong predictor of device return, then the manufacturer can release a software patch or otherwise provide instructions to prevent the device from disconnecting with the network. Examples are not so limited, and any number of different actions can be taken by the manufacturer to preempt the return of devices based on extrapolated data.

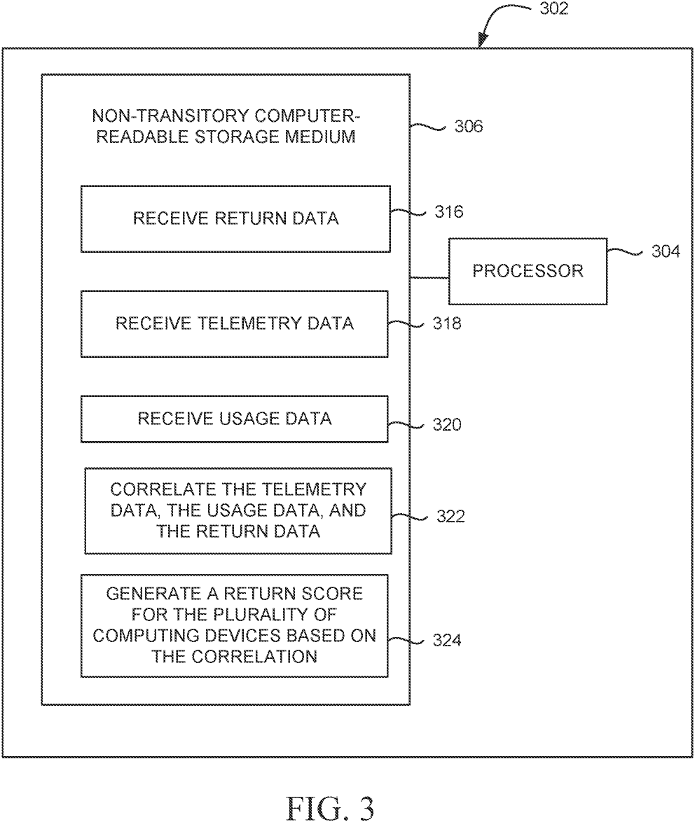

FIG. 3 illustrates an example computing device 302 for extrapolating return data for a plurality of computing devices, in accordance with the present disclosure. In general, the computing device 302 shown in FIG. 3 may include various components that are the same and/or substantially similar to the computing device 202 shown in FIG. 2, which was described in greater detail above. As such, for brevity and ease of description, various details relating to certain components in the computing device 302 shown in FIG. 3 may be omitted herein to the extent that the same or similar details have already been provided above in relation to the computing device 202 illustrated in FIG. 2.

As illustrated in FIG. 3, the computing device 302 may include a processor 304, and a computer-readable storage medium 306. The computer-readable storage medium 306 may be encoded with a series of executable instructions 316-324. The computer-readable storage medium 306 may include instructions 316 that when executed cause the computing device 302 to receive return data from a subpart of a plurality of computing devices setup on a network hosted by the computing device. In some examples, the computing device 302 may be a computing device remote to the computing device being setup on the network. As such, the computing device 302 may receive the return data over a network connection, such as may be implemented in a cloud-based solution.

The computer-readable storage medium 306 may include instructions 318 that when executed cause the computing device 302 to receive from the plurality of computing devices setup on the network, telemetry data associated with setup. As discussed herein, telemetry data may be collected locally by the computing device being setup on the network, and/or telemetry data may be collected remotely.

The computer-readable storage medium 306 may include instructions 320 that when executed cause the computing device 302 to receive usage data pertaining to the plurality of computing devices, the usage data including data obtained during setup of the plurality of computing devices.

The computer-readable storage medium 306 may include instructions 322 that when executed cause the computing device 302 to correlate the telemetry data, the usage data, and the return data. In some examples, the instructions 320 to correlate the telemetry data and the return data include instructions to correlate the telemetry data and the return data using a serial number for the respective computing device. As described with regards to FIG. 1, the telemetry data and the return data may be correlated by converting the telemetry data and the return data into a common format. Correlation may include converting return data to numerical format from text and/or categorical format. Correlation of the telemetry data with the return data may be performed by the computing device being setup on the network or by a remote computing device, such as may be implemented in a cloud-based solution.

The computer-readable storage medium 306 may include instructions 324 that when executed cause the computing device 302 to generate a return score for the plurality of computing devices based on the correlation of the telemetry data, the usage data, and the return data. As used herein, a return score refers to or includes a metric that represents the likelihood that computing device will be returned.

In some examples, the computer-readable storage medium 306 may include instructions that when executed cause the computing device 302 to classify each computing device among the subpart of the plurality of computing devices as a return device or a non-returned device. Using predictive modeling, as described herein, the return data may be extrapolated to users that did not return their devices. As such, the computer-readable storage medium 306 may include instructions that when executed cause the computing device 302 to classify each of a remainder of the plurality of computing devices as a return device or a non-returned device based on data for the identified features. Moreover, in some examples, the computer-readable storage medium 306 may include instructions that when executed cause the computing device 302 to identify a plurality of features of the telemetry data that influenced the classification for each computing device among the subpart of the plurality of computing devices.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
receiving telemetry data from a plurality of computing devices, the telemetry data including data obtained during setup of the plurality of computing devices;
receiving usage data pertaining to the plurality of computing devices, the usage data including data obtained during setup of the plurality of computing devices;
receiving return data pertaining to a subpart of the plurality of computing devices;
correlating the received telemetry data and the received usage data with the received return data; and
extrapolating return data for a remainder of the plurality of computing devices based on the correlation between the received telemetry data, the received usage data, and the received return data.

2. The method of claim 1, wherein correlating the received telemetry data, the received usage data, and the received return data includes selecting a plurality of features from the telemetry data to correlate with the return data.

3. The method of claim 1, wherein correlating the received telemetry data, the received usage data, and the received return data includes selecting a plurality of features from the received usage data to correlate with the return data.

4. The method of claim 1, further including:
receiving call data pertaining to the plurality of computing devices, the call data including data obtained during setup of the plurality of computing devices;
correlating the received call data with the received return data; and
extrapolating return data for the remainder of the plurality of computing devices based at least in part on the correlation between the received call data and the received return data.

5. The method of claim 1, wherein extrapolating return data includes determining for each of a remainder of the plurality of computing devices, whether the respective computing device would be classified as a return device or a non-returned device.

6. A non-transitory computer-readable storage medium comprising instructions that when executed cause a computing device to:
receive telemetry data from a plurality of computing devices, the telemetry data including data obtained during a setup process of the plurality of computing devices;
receive usage data pertaining to the plurality of computing devices, the usage data including data obtained during the setup process of the plurality of computing devices;
receive return data pertaining to a subpart of the plurality of computing devices; and
create a predictive model to infer if a computing device among the plurality of computing devices is a return device, or non-returned device, by correlating the received telemetry data, the received usage data, and the received return data.

7. The medium of claim 6, including instructions that when executed, cause the computing device to determine which of a plurality of features of the telemetry data have a greatest association with return data as compared to a remainder of the plurality of features of the telemetry data.

8. The medium of claim 6, including instructions that when executed, cause the computing device to determine which features of usage data contribute the most to the computing device being returned.

9. The medium of claim 6, including instructions that when executed, cause the computing device to identify an aspect of the setup process to modify based on the predictive model.

10. The medium of claim 6, wherein the predictive model includes logistic regression, random forest, or catboost, or combinations thereof.

11. A non-transitory computer-readable storage medium comprising instructions that when executed cause a computing device to:
receive return data from a subpart of a plurality of computing devices setup on a network hosted by the computing device;
receive from the plurality of computing devices setup on the network, telemetry data associated with setup;
receive usage data pertaining to the plurality of computing devices, the usage data including data obtained during setup of the plurality of computing devices;
correlate the telemetry data, the usage data, and the return data; and
generate a return score for the plurality of computing devices based on the correlation of the telemetry data, the usage data, and the return data.

12. The medium of claim 11, wherein the instructions to correlate the data include instructions to correlate the data using a serial number for the respective computing device.

13. The medium of claim 11, including instructions that when executed cause the computing device to classify each computing device among the subpart of the plurality of computing devices as a detractor return device or a non-returned device.

14. The medium of claim 13, including instructions that when executed cause the computing device to identify a plurality of features of the telemetry data that influenced the classification for each computing device among the subpart of the plurality of computing devices.

15. The medium of claim 14, including instructions that when executed cause the computing device to classify each of a remainder of the plurality of computing devices as a return device or a non-returned device based on data for the identified features.
